(19) United States
(12) Patent Application Publication
(10) Pub. No.: US 2024/0208457 A1
(43) Pub. Date: Jun. 27, 2024

(54) Seat Belt with IR Absorbing Material Woven Pattern

(71) Applicant: Perceptive Solutions Inc., Simpsonville, SC (US)

(72) Inventor: Phillip W. Evans, Greenville, SC (US)

(21) Appl. No.: 18/216,389

(22) Filed: Jun. 29, 2023

Related U.S. Application Data
(63) Continuation-in-part of application No. PCT/US21/65474, filed on Dec. 29, 2021.
(60) Provisional application No. 63/131,358, filed on Dec. 29, 2020.

(51) Int. Cl. B60R 22/12; C08K 3/38; D01F 1/10; D01F 6/62; D03D 1/00; D03D 15/283; D03D 15/50

(52) U.S. Cl. CPC B60R 22/12; C08K 3/38; D01F 1/106; D01F 6/62; D03D 1/0005; D03D 15/283; D03D 15/50; C08K 2201/005; D10B 2331/04; D10B 2401/00; D10B 2505/122

(57) ABSTRACT

A seat belt webbing (100) includes a plurality of strands of infra-red reflecting yarn (112). A plurality of strands of infra-red absorbing yarn (110) are interwoven with the strands of infra-red reflecting yarn (112) to form the webbing with a pattern that is identifiable when the webbing (100) is subjected to infra-red light. An infra-red absorbing yarn precursor masterbatch includes a thermoplastic and an infra-red absorber mixed therein. The mixture is cut into a plurality of pellets for subsequent addition to thermoplastic pellets. In a method of making a fabric an infra-red absorber is added to a thermoplastic to form a homogenous mixture, which is extruded and spun to form an infra-red absorbing yarn. The infra-red absorbing yarn along with infra-red reflecting yarn is woven to form the fabric that has an identifiable infra-red absorbing pattern therein.

### CROSS-REFERENCE TO RELATED APPLICATION(S)

This application is a continuation-in-part of and claims the benefit of PCT Application No. PCT/US21/65474, filed Dec. 29, 2021, which claims the benefit of U.S. Provisional Patent Application Ser. No. 63/131,358, filed Dec. 29, 2020, the entirety of each of which is hereby incorporated herein by reference.

### BACKGROUND OF THE INVENTION

### 1. Field of the Invention

The present invention relates to a seat belt material and, more specifically, to a seat belt material having an IR camera-recognizable pattern.

### 2. Description of the Related Art

The use of seatbelts have saved millions of lives of automobile crash victims. For decades, vehicles (such as automobiles) have utilized safety switches in seatbelt buckles as an indicator of whether seatbelts are properly fastened. Numerous types of systems are used to detect seat belt usage vehicles. Many vehicles include a pressure sensor in the passenger seats, which determine whether a seat is occupied, and an electrical switch mounted in the buckle that is in a first state if the seat belt is not buckled and a second state if the seat belt is buckled. A simple logic circuit generates an alarm when the pressure sensor indicates that a passenger is in a seat and when the electrical switch indicates that the seat belt is not buckled. Once the seat belt is buckled, the alarm is turned off.

For various reasons, some people try to defeat such sensors. For example, a passenger might buckle the seatbelt, but sit on top of it. As a result, while the pressure sensor in the seat indicates that there is a passenger sitting on it, the electrical switch will indicate that the seat belt is buckled, and the logic circuit will not sound the alarm. Mechanical safety switches can also experience mechanical and electrical malfunctions.

Some vehicles are equipped with infra-red (IR) sensing cameras pointed at the occupants of the vehicle. With such systems, there have been attempts to sense the presence of the seat belt in front of the passenger by sensing differences in the IR radiation profile generated by the passenger. In these attempts, if a stripe of low intensity reflected IR radiation that corresponds to the correct placement of the shoulder belt surrounded by an area of higher intensity reflected IR radiation corresponding to the shape of the passenger is sensed, then the system presumes that the passenger is wearing the seat belt properly. However, the seat belt will heat up to the body temperature of the passenger shortly after it is secured, which results in no detectable interface in the IR image, which can result in a false alarm.

There have also been attempts to shine light from an IR LED on the passenger and a seat belt on which is printed a pattern of a highly IR-reflective coating. However, such a system can generate spurious results if the passenger is wearing clothing that is also IR-reflective. Additionally, coatings printed on seat belts can wear off after normal use and most IR dyes tend to be unstable after prolonged exposure to sunlight.

Because each automotive OEM has different requirements, Seat belt yarn processing parameters can vary from one yarn manufacturer to another. For example, although automotive interior lightfastness test SAE J 1885 consistently requires a 20 year sunlight simulation test in order to meet Government regulations, yarn extrusion temperatures can range from below 280° C. in one yarn manufacturing process to above 350° C. in another.

There have been several proposals to add employ infrared absorbers with seat belts. However, such proposals fail to disclose an effective combination of materials or an effective method of making infrared absorbing web materials that would have a long term (e.g., 20 year) effective lifespan.

Therefore, there is a need for a system that detects the presence of a properly applied seat belt using IR radiation that will not wear off after repeated use.

### SUMMARY OF THE INVENTION

The disadvantages of the prior art are overcome by the present invention which, in one aspect is a seat belt webbing that includes a plurality of strands of infra-red reflecting yarn and a plurality of strands of infra-red absorbing yarn. The plurality of strands of infra-red absorbing yarn interwoven with the strands of infra-red reflecting yarn to form the webbing with a pattern that is identifiable when the webbing is subjected to infra-red light.

In another aspect, the invention, is an infra-red absorbing yarn precursor masterbatch that includes a thermoplastic and an infra-red absorber. The infra-red absorber includes Lanthanum Hexaboride particles having a particle size in a range of 50 nm to 80 nm mixed into the thermoplastic,

In yet another aspect, the invention, is a method of making a fabric, in which a predetermined amount of an infra-red absorber is added to a thermoplastic. The thermoplastic is melted with the infra-red absorber at a temperature of about 300° C. and the thermoplastic is mixed with the infra-red absorber so as to form a homogenous mixture. The homogenous mixture is extruded and spun so as to form an infra-red absorbing yarn. The infra-red absorbing yarn is woven along with infra-red reflecting yarn to form the fabric with an identifiable infra-red absorbing pattern therein.

In yet another aspect, the invention is a method of making a fabric in which a predetermined amount of an infra-red absorber is added to a thermoplastic. The thermoplastic melted with the infra-red absorber and the thermoplastic is mixed with the infra-red absorber so as to form a homogenous mixture. The homogenous mixture is extruded and spun so as to form an infra-red absorbing yarn. The infra-red absorbing yarn along with non-infra-red absorbing yarn is woven to form the fabric so as to have the identifiable infra-red absorbing pattern therein.

### BRIEF DESCRIPTION OF THE FIGURES OF THE DRAWINGS

FIG. 1A is a schematic diagram of a patterned IR attenuating seat belt illuminated with visible light.

FIG. 1B is a schematic diagram of a patterned IR attenuating seat belt illuminated with infra-red light.

FIG. 2 is a schematic diagram of a user wearing a patterned IR attenuating seat belt illuminated with infra-red light.

FIG. 3 is a photograph of a piece of seat belt material illuminated with visible light and then illuminated with IR radiation.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. The present disclosure should in no way be limited to the exemplary implementations and techniques illustrated in the drawings and described below. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

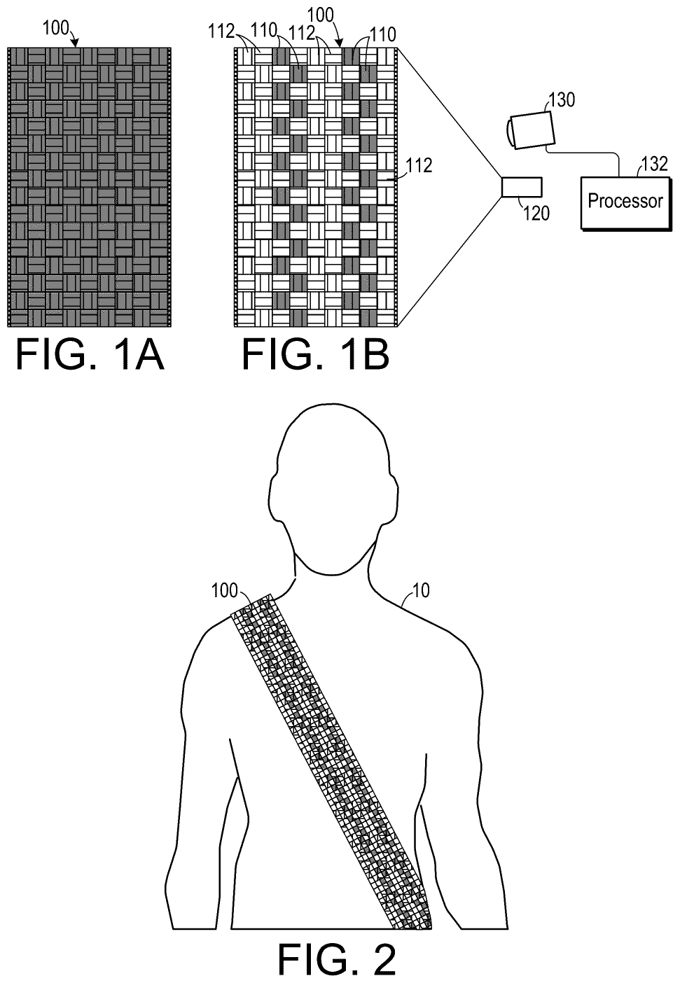

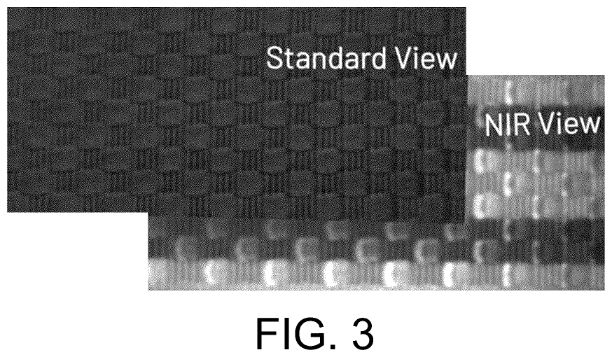

As shown in FIGS. 1A, 1B, 2 and 3, one embodiment of a seat belt 100 includes a machine-recognizable pattern of IR absorbing yarn 110 interwoven with non-IR absorbing yarn 112 to form, for example, a seat belt web. When the seat belt 100 is illuminated with visible light, the pattern is not readily detectable. However, when the seat belt 100 is illuminated with IR light 120 (e.g., by an IR generating LED), the pattern of IR absorbing yarn 110 and non-IR absorbing yarn 112 will become distinctly detectable by an IR-sensitive driver monitoring camera (DMC) 130. A processor 132 employing pattern recognition software can then determine if the seat belt 100 is positioned properly, which indicates that it is being worn by a user 10. While the pattern shown includes two stripes running along the length of the seat belt 100, it is understood than many other patterns can be woven into the seat belt 100 according to the invention. A typical DMC operates with a peak sensitivity of 940 nanometers. Therefore, preferably the near infrared absorber is a powder with heavy absorption near 940 nanometers and low absorption 400-700 nm.

With the invention and widespread planned implementation of onboard infra-red DMCs in automobiles in the near future, a substantial advance in seatbelt safety can be made by implementing infra-red technology into the seat belt webbing for the purpose of recognition of distinct patterns by the DMC. These unique patterns can be used by the DMC to precisely determine if the driver and/or passengers have properly routed and fastened seatbelts. Many possible classes of near infrared-absorbing materials, including but not limited to: Cyanine, isocyanine, phthalocyanine, naphthalocyanine, squarylium, metal complex, and inorganic materials.

The yarn used to make the patterns is made by adding IR absorbing molecules to polyester and then extruding the mixture to make yarn. Since normal polyester tends to be naturally reflective of near infra-red light in the 800-1000 nanometer wavelength range (the wavelength range generated by many IR-emitting LEDs); IR absorption naturally creates more contrast with such IR-reflective materials.

The IR absorbing yarn can be made from one of many classes of near infra-red dyes, including but not limited to cyanine, isocyanine, phthalocyanine, naphthalocyanine, squarylium, and metal complex.

A typical DMC operates with a peak wavelength sensitivity of 940 nanometers. Therefore, preferably the near infra-red absorber is a powder with a peak wavelength absorption near 940 nanometers. One suitable absorber is C₃₂H₂₈O₄S₄Ni, or Bis(4,4′-dimethoxydithiobenzyl) nickel (available from American Dye Source). In one representative method of making a near infra-red absorbing polyester yarn that absorbs at 940 nm is to introduce 1 to 2 parts of this absorber into 5,000 parts polyester, heating the polyester to just above 300 degrees C. and mixing until homogenous. The resulting mixture is then extruded into the proper yarn size and weight for the desired application (which is DTEX1100 for seat belt yarns) to generate the yarn, which is then woven into seat belt webbing.

In an alternative embodiment, two other near-infra-red powders that operate in desired wavelength range are PF3-980 and PF3-1000 antimony doped tin oxide powders (both available from Perceptive Solutions Inc., Simpsonville, SC), which are a 50-90 nm dispersions of tin oxide in ethylene glycol. In one method for making near-infra-red absorbing polyester from either of these, 1 to 10 parts powder are introduced into 2,000 parts polyester at a temperature slightly above 300 degrees C., which is mixed until homogenous. The resulting mixture is then extruded into the DTEX1100 yarn and woven into seat belting to create the desired recognizable pattern.

A preferred near infra-red absorber is Indium Tin Oxide (available from Perceptive Solutions Inc.), which exhibits low visible light absorption. In this embodiment 1 to 10 parts indium tin oxide is introduced into 2,000 parts polyester at a temperature slightly above 300 degrees C. and is mixed until homogenous. The resulting mixture is then extruded into DTEX1000 IR-absorbing yarn and a pattern is created in the seat belting by weaving the IR-colored yarn in combination with IR-uncolored polyester yarn

In certain embodiments, it may be preferable to make a highly concentrated IR color polyester masterbatch. Then the masterbatch would be introduced into the final mix to obtain the desired concentration. The masterbatch would include a thermoplastic with an infra-red absorbing additive (of one of the types disclosed above) mixed into the thermoplastic. The resulting mixture is extruded, cooled and then cut into pellets. The masterbatch can be shipped and stored easily. In use, the pellets are added to clear thermoplastic pellets in an amount that results in the desired concentration of infra-red absorber in the thermoplastic. This combination is then melted, extruded and spun into IR absorbing yarn. The master batch allows for easy storage and mixing of the IR absorber with the thermoplastic.

The following four representative embodiments for making such are yarn are described below:

Embodiment 1: Employing Indium Tin Oxide (ITO) (Available from Nyacol Nanotechnologies). In this method of making a near infrared absorbing polyester yarn that absorbs at 940 nm, three parts of this absorber is introduced into 1000 parts polyester; the polyester is heated to just above 300° C. and is mixed until homogenous. The resulting mixture is then extruded into the proper yarn size and weight for the desired application (which is DTEX1100 for seat belt yarns) to generate the yarn and is then woven into seat belting.

Embodiment 2: Employing Antimony-doped Indium Tin Oxide (ATO). Two near-infrared powders that operate in desired wavelength range are SN902 and SN903 antimony doped tin oxide powders (both available from Nyacol Nanotechnologies). In this embodiment, two parts ATO is introduced into 1,000 parts polyester at a temperature slightly above 300° C. and is mixed until homogenous. The resulting mixture is then extruded into DTEX1000 IR-absorbing yarn and a pattern is created in the seat belting by weaving the IR-colored yarn in combination with uncolored polyester yarn.

Embodiment 3: Employing modified Tungsten Oxide (CTO) (available from Keeling Walker in UK). In this embodiment, four parts CTO and 20 parts micro zinc oxide (ZnO) are introduced into 10,000 parts polyester and the mixture is heated to slightly above 300° C. and mixed until homogenous. The resulting mixture is then extruded into DTEX1000 IR-absorbing yarn and a pattern is created in the seat belting by weaving the IR-colored yarn in combination with uncolored polyester yarn. Micro Zinc oxide is used as a UV stabilizer because of its high heat stability but can be replaced by other high temperature resistant UV stabilizers such as cerium oxide, Zirconium Oxide, or a combination of the three. Titanium dioxide, one of the most common UV stabilizers, may not be recommended in certain embodiments.

Embodiment 4: Employing Lanthanum Hexaboride (employing LaB6 50-80 nanometer size particles, available from SkySpring Nanomaterials, Inc.). In this embodiment, 2 parts LaB6 is introduced into 10,000 parts polyester. The resulting combination is heated to slightly above 300° C. and is mixed until homogenous. The resulting mixture is then extruded into DTEX1000 IR-absorbing yarn and a pattern is created in the seat belting by weaving the IR-colored yarn in combination with uncolored polyester yarn. Use of 50 nm to 80 nm particle size LaB6 or smaller is preferable. Particles larger than 250 nm may not absorb light at 940 nm sufficiently for recognition purposes and may be absorbed too heavily in the 400 nm to 700 nm range.

Other parts of a vehicle may use IR-absorbing yarn patterns. For example, such patterns could be woven into headrests to help determine the position of the occupant's head to facilitate optimal airbag deployment. Also, such patterns woven into the fabric of a seat back could be used in the detection of a baby carrier or child safety seat.

Although specific advantages have been enumerated above, various embodiments may include some, none, or all of the enumerated advantages. Other technical advantages may become readily apparent to one of ordinary skill in the art after review of the following figures and description. It is understood that, although exemplary embodiments are illustrated in the figures and described below, the principles of the present disclosure may be implemented using any number of techniques, whether currently known or not. Modifications, additions, or omissions may be made to the systems, apparatuses, and methods described herein without departing from the scope of the invention. The components of the systems and apparatuses may be integrated or separated. The operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. It is intended that the claims and claim elements recited below do not invoke 35 U.S.C. § 112(f) unless the words “means for” or “step for” are explicitly used in the particular claim. The above-described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A seat belt webbing, comprising:
(a) a plurality of strands of infra-red reflecting yarn; and
(b) a plurality of strands of infra-red absorbing yarn interwoven with the strands of infra-red reflecting yarn to form the webbing with a pattern that is identifiable when the webbing is subjected to infra-red light.

2. The seat belt of claim 1, wherein the strands of infra-red absorbing yarn comprise:
(a) a thermoplastic; and
(b) an infra-red absorber mixed with the thermoplastic.

3. The seat belt of claim 2, wherein the infra-red absorber has a peak wavelength sensitivity of 940 nanometers.

4. The seat belt of claim 2, wherein the infra-red absorber comprises Lanthanum Hexaboride particles having a particle size in a range of 50 nm to 80 nm.

5. The seat belt of claim 4, wherein the strands of infra-red absorbing yarn comprise two parts Lanthanum Hexaboride and 10,000 parts polyester.

6. The seat belt of claim 2, wherein the infra-red absorber comprises a material selected from a list consisting of: Indium Tin Oxide; Antimony-doped Indium Tin Oxide; Modified Tungsten Oxide; and combinations thereof.

7. The seat belt of claim 2, wherein the strands of infra-red absorbing yarn comprise 3 parts indium tin oxide mixed with 10,000 parts polyester.

8. The seat belt of claim 2, wherein the strands of infra-red absorbing yarn comprise: 4 parts modified Tungsten Oxide and 20 parts micro zinc oxide mixed with 10,000 parts polyester powder.

9. The seat belt of claim 1, wherein the strands of infra-red reflecting yarn comprise a thermoplastic.

10. The seat belt of claim 9, wherein the thermoplastic comprises polyester.

11. The seat belt of claim 1, wherein the pattern comprises at least one elongated stripe of strands of infra-red absorbing yarn running along the length of the seat belt.

12. An infra-red absorbing yarn precursor masterbatch, comprising:
(a) a thermoplastic; and
(b) an infra-red absorber including Lanthanum Hexaboride particles having a particle size in a range of 50 nm to 80 nm mixed into the thermoplastic,

13. The infra-red absorbing yarn precursor masterbatch of claim 12, wherein the strands of infra-red absorbing yarn comprise two parts Lanthanum Hexaboride and 10,000 parts polyester.

14. The infra-red absorbing yarn precursor masterbatch of claim 12, wherein the thermoplastic and infra-red absorber mixture is cut into a plurality of pellets for subsequent addition to thermoplastic pellets.

15. The infra-red absorbing yarn precursor masterbatch of claim 12, wherein the thermoplastic comprises polyester.

16. The infra-red absorbing yarn precursor masterbatch of claim 12, wherein the infra-red absorber has a peak wavelength sensitivity of 940 nanometers.

17. A method of making a fabric, comprising the steps of:
(a) adding a predetermined amount of an infra-red absorber to a thermoplastic;
(b) melting the thermoplastic with the infra-red absorber at a temperature of about 300° C. and mixing the thermoplastic with the infra-red absorber so as to form a homogenous mixture;
(c) extruding and spinning the homogenous mixture so as to form an infra-red absorbing yarn;
(d) weaving the infra-red absorbing yarn along with infra-red reflecting yarn to form the fabric with an identifiable infra-red absorbing pattern therein.

18. The method of claim 17, wherein the infra-red reflecting yarn comprises polyester.

19. The method of claim 17, wherein the infra-red absorber comprises Lanthanum Hexaboride particles having a particle size in a range of 50 nm to 80 nm.

20. The method of claim 19, wherein the step of adding a predetermined amount of an infra-red absorber to a thermoplastic comprises adding two parts Lanthanum Hexaboride to 10,000 parts polyester.
